(19) United States
(12) Patent Application Publication
(10) Pub. No.: US 2020/0310325 A1
(43) Pub. Date: Oct. 1, 2020

(54) MAINTENANCE GUIDE GENERATION METHOD AND IMAGE FORMING APPARATUS

(71) Applicant: Oki Data Corporation, Tokyo (JP)

(72) Inventor: Yoshiharu MURATA, Tokyo (JP)

(73) Assignee: Oki Data Corporation, Tokyo (JP)

(21) Appl. No.: 16/813,326

(22) Filed: Mar. 9, 2020

(30) Foreign Application Priority Data
Mar. 29, 2019 (JP) 2019-068592

(51) Int. Cl. G03G 15/00

(52) U.S. Cl. CPC G03G 15/70

(57) ABSTRACT

A maintenance guide generation method includes: detecting occurrences of a plurality of errors; determining, on a basis of the detecting, whether the plurality of errors have occurred; when the determining determines that the plurality of errors have occurred, reading, for each of the plurality of errors, a maintenance guide corresponding to the error and including a plurality of maintenance steps; and generating a combined maintenance guide by combining the maintenance guides in a predetermined order while removing a duplicate maintenance step of the maintenance steps of the maintenance guides.

### BACKGROUND OF THE INVENTION

### 1. Field of the Invention

The present invention relates to a maintenance guide generation method and an image forming apparatus.

### 2. Description of the Related Art

Conventionally, there is an image forming apparatus that stores guides corresponding to errors, such as sheet jams at different locations or toner cartridge replacement errors, and when one of the errors occurs, displays the guide corresponding to the error to allow a user to perform an operation for removing the error in accordance with the guide (see, e.g., Japanese Patent Application Publication No. 2013-24952).

When multiple errors occur, the conventional image forming apparatus may sequentially display the guides corresponding to the multiple errors to allow the user to sequentially perform operations for removing the errors in accordance with the guides. This may force the user to perform duplicate operations. For example, the user may be forced to open a cover of the image forming apparatus, perform an operation for removing an error, close the cover, and then open the closed cover again to perform an operation for removing another error. This is inconvenient.

### SUMMARY OF THE INVENTION

An object of an aspect of the present invention is to provide a maintenance guide generation method and an image forming apparatus capable of generating a convenient maintenance guide.

According to an aspect of the present invention, there is provided a maintenance guide generation method including: detecting occurrences of a plurality of errors; determining, on a basis of the detecting, whether the plurality of errors have occurred; when the determining determines that the plurality of errors have occurred, reading, for each of the plurality of errors, a maintenance guide corresponding to the error and including a plurality of maintenance steps; and generating a combined maintenance guide by combining the maintenance guides in a predetermined order while removing a duplicate maintenance step of the maintenance steps of the maintenance guides.

According to another aspect of the present invention, there is provided an image forming apparatus including: a detector that detects occurrences of a plurality of errors; a determiner that determines, on a basis of detection by the detector, whether the plurality of errors have occurred; a reader that, when the determiner determines that the plurality of errors have occurred, reads, for each of the plurality of errors, a maintenance guide corresponding to the error and including a plurality of maintenance steps, from a storage; and a generator that generates a combined maintenance guide by combining the maintenance guides in a predetermined order while removing a duplicate maintenance step of the maintenance steps of the maintenance guides.

According to another aspect of the present invention, there is provided an image forming apparatus including: a detector that detects occurrences of a plurality of errors; a determiner that determines, on a basis of detection by the detector, whether the plurality of errors have occurred; a reader that, when the determiner determines that the plurality of errors have occurred, reads, for each of the plurality of errors, a maintenance guide corresponding to the error and including a plurality of maintenance steps, from a storage, the maintenance guides including a first maintenance guide and a second maintenance guide; and a generator that generates a combined maintenance guide by combining the maintenance guides so that the first maintenance guide is followed by the second maintenance guide, and adding, between the first maintenance guide and the second maintenance guide, a step of indicating that the second maintenance guide exists following the first maintenance guide.

### BRIEF DESCRIPTION OF THE DRAWINGS

In the attached drawings:

FIG. 1 is a view illustrating a configuration of an image forming apparatus;

FIG. 2 is a block diagram illustrating a control configuration of the image forming apparatus;

FIG. 3 is a block diagram illustrating a functional configuration of the image forming apparatus;

FIG. 4 is a flowchart illustrating a jam removal guide display process;

FIG. 5 is a view illustrating a front cover opening instruction screen of a sheet feed jam removal guide;

FIG. 6 is a view illustrating a jammed sheet drawing instruction screen of the sheet feed jam removal guide;

FIG. 7 is a view illustrating a front cover closing instruction screen of the sheet feed jam removal guide;

FIG. 8 is a view illustrating a front cover opening instruction screen of a conveyance jam removal guide;

FIG. 9 is a view illustrating a discharged sheet tray opening instruction screen of the conveyance jam removal guide;

FIG. 10 is a view illustrating an image drum removing instruction screen of the conveyance jam removal guide;

FIG. 11 is a view illustrating a jammed sheet drawing instruction screen of the conveyance jam removal guide;

FIG. 12 is a view illustrating an image drum reinstalling instruction screen of the conveyance jam removal guide;

FIG. 13 is a view illustrating a discharged sheet tray closing instruction screen of the conveyance jam removal guide;

FIG. 14 is a view illustrating a front cover closing instruction screen of the conveyance jam removal guide;

FIG. 15 is a view illustrating a front cover opening instruction screen of a multiple jam removal guide;

FIG. 16 is a view illustrating a jammed sheet drawing instruction screen of the multiple jam removal guide;

FIG. 17 is a view illustrating a following guide indicating screen of the multiple jam removal guide;

FIG. 18 is a view illustrating a discharged sheet tray opening instruction screen of the multiple jam removal guide;

FIG. 19 is a view illustrating an image drum removing instruction screen of the multiple jam removal guide;

FIG. 20 is a view illustrating a jammed sheet drawing instruction screen of the multiple jam removal guide;

FIG. 21 is a view illustrating an image drum reinstalling instruction screen of the multiple jam removal guide;

FIG. 22 is a view illustrating a discharged sheet tray closing instruction of the multiple jam removal guide;

FIG. 23 is a view illustrating a front cover closing instruction screen of the multiple jam removal guide;

FIG. 24 is a flowchart illustrating a multiple jam removal guide generation process;

FIG. 25 is a diagram for explaining the multiple jam removal guide generation process;

FIG. 26 is a block diagram illustrating a functional configuration of the image forming apparatus; and

FIG. 27 is a block diagram illustrating a hardware configuration of the image forming apparatus.

### DETAILED DESCRIPTION OF THE INVENTION

An embodiment of the present invention will now be described with reference to the attached drawings.

### <1. Configuration of Image Forming Apparatus>

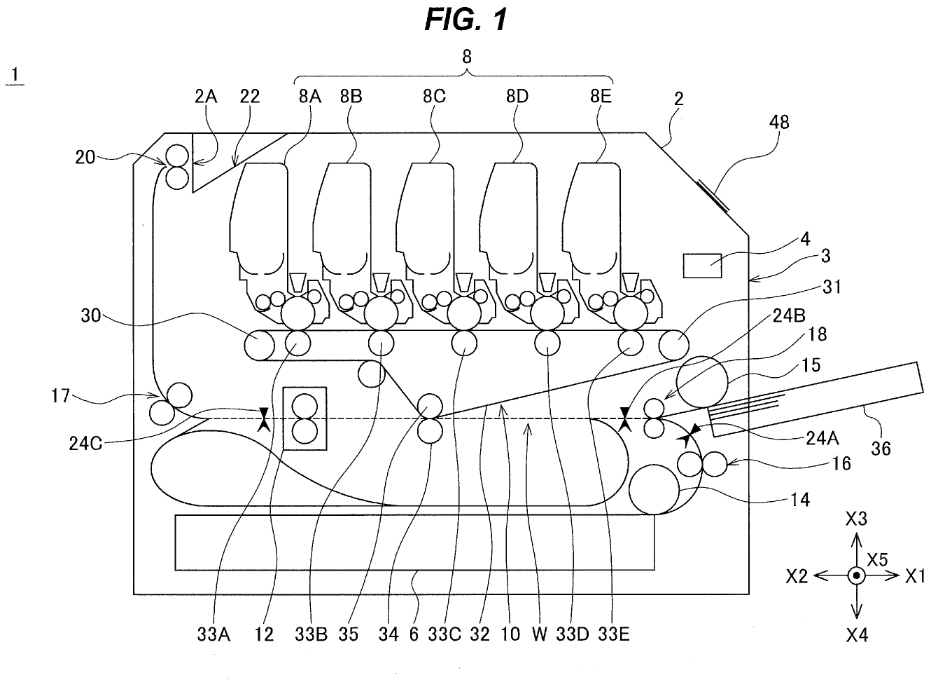

FIG. 1 illustrates an image forming apparatus 1 according to an embodiment. In the following description, the right end of the image forming apparatus 1 in FIG. 1 is assumed to be a front side of the image forming apparatus 1, and an up-down direction, a left-right direction, and a front-rear direction are defined as viewed toward the front side. In FIG. 1, arrows X1, X2, X3, X4, and X5 indicate the forward, rearward, upward, downward, and leftward directions, respectively.

As illustrated in FIG. 1, the image forming apparatus 1 includes a substantially box-shaped housing 2, in which various components are disposed. The housing 2 includes openings that are formed on the front side and upper side and through which an interior space surrounded by the housing 2 communicates with the outside. The housing 2 also includes a front cover 3 disposed on the front side and serving as a cover for opening and closing the front opening, and a discharged sheet tray 22 disposed on the upper side and serving as a cover for opening and closing the upper opening. During printing operation, the front cover 3 and discharged sheet tray 22 are closed to protect the interior of the image forming apparatus 1. On the other hand, when a user, such as a maintenance operator, performs a maintenance operation, at least one of the front cover 3 and discharged sheet tray 22 is opened as needed, thereby allowing the user to easily perform operations to portions inside the housing 2.

The image forming apparatus 1 includes a controller 4 that entirely controls the image forming apparatus 1. The controller 4 is connected wirelessly or by wire to a host apparatus (not illustrated), such as a computer apparatus. Upon receiving, from the host apparatus, image data representing an image to be printed and a command to print the image data, the controller 4 performs a print process to form a printed image on a surface of a sheet. The image forming apparatus 1 includes, in the housing 2, a sheet cassette 6, multiple image forming units 8 (specifically, image forming units 8A, 8B, 8C, 8D, and 8E), an intermediate transfer unit 10, a fixing unit 12, sheet feed rollers 14 and 15, pairs of conveying rollers 16 and 17, a pair of registration rollers 18, a pair of discharging rollers 20, a sheet feed sensor 24A, a writing sensor 24B, and a discharge sensor 24C.

The sheet cassette 6 is a portion for storing sheets, such as paper sheets, and is disposed in a lower part of the housing 2. The multiple image forming units 8 are units that perform an image forming process of electrophotography, and are disposed in an upper part of the housing 2. The multiple image forming units 8 use different developers. For example, the image forming unit 8A uses black developer, the image forming unit 8B uses yellow developer, the image forming unit 8C uses magenta developer, the image forming unit 8D uses cyan developer, and the image forming unit 8E uses black developer. For example, the developer is toner. Each image forming unit 8 may include a photosensitive drum (or image drum) on which a toner image is formed. Each image forming unit 8 may also include a toner cartridge that stores toner. The image forming units 8A, 8B, 8C, 8D, and 8E have the same configuration, and differ only in that their toners are different in color.

The intermediate transfer unit 10 is a unit that performs a transfer process of electrophotography, and is disposed under the multiple image forming units 8. The intermediate transfer unit 10 includes a belt tension roller 30, a belt drive roller 31, an intermediate transfer belt 32, multiple primary transfer rollers 33 (specifically, 33A to 33E), a secondary transfer roller 34, and a secondary transfer backup roller 35.

The intermediate transfer belt 32 is stretched by the belt tension roller 30, belt drive roller 31, and secondary transfer backup roller 35 in an inverted triangular shape with its upper side flat and its lower side projecting downward. The primary transfer rollers 33A to 33E are disposed inside an upper flat portion of the intermediate transfer belt 32 to respectively face the image forming units 8A to 8E with a portion of the intermediate transfer belt 32 extending in the front-rear direction therebetween. The secondary transfer roller 34 is disposed outside a lower projecting portion of the intermediate transfer belt 32 to face the secondary transfer backup roller 35 with the intermediate transfer belt 32 therebetween.

As the intermediate transfer belt 32 is traveling clockwise in FIG. 1, toner images are transferred from the multiple image forming units 8 (8A to 8E) onto an outer surface of the upper flat portion of the intermediate transfer belt 32 by the multiple primary transfer rollers 33 (33A to 33E). The toner images thus transferred onto the intermediate transfer belt 32 are conveyed clockwise in FIG. 1 together with the intermediate transfer belt 32, and when a sheet conveyed to a nip portion formed between the secondary transfer roller 34 and the secondary transfer backup roller 35 passes through the nip portion, the toner images are transferred onto the sheet.

The fixing unit 12 is a unit that performs a fixing process of electrophotography, and is disposed downstream of the nip portion formed between the secondary transfer roller 34 and the secondary transfer backup roller 35 in a sheet conveying direction in which the sheet is conveyed. The fixing unit 12 includes a heating roller and a pressure roller that face each other with a conveyance path W along which the sheet is conveyed in the front-rear direction, therebetween. The heating roller is formed in a cylindrical shape with a central axis extending in the left-right direction, and a heater is disposed inside the heating roller. The pressure roller is formed in a cylindrical shape similar to that of the heating roller. An upper surface of the pressure roller is pressed against a lower surface of the heating roller at a predetermined pressing force. The fixing unit 12 heats the heating roller and rotates the heating roller and pressure roller in respective predetermined directions under control of the controller 4. Thereby, the fixing unit 12 applies heat and pressure to the sheet conveyed from the intermediate transfer unit 10, i.e., the sheet with the toner images transferred and superimposed thereon, to fix the toner images to the sheet, and further conveys it rearward.

The sheet feed roller 14 is a roller for feeding a sheet from the sheet cassette 6 to the conveyance path W. The pair of conveying rollers 16 are rollers for conveying the sheet fed from the sheet cassette 6 to the pair of registration rollers 18, and are pressed against each other with the conveyance path W therebetween. The pair of registration rollers 18 are rollers for correcting skew of the sheet conveyed by the pair of conveying rollers 16 and conveying the sheet to the nip portion between the secondary transfer roller 34 and the secondary transfer backup roller 35, and are pressed against each other with the conveyance path W therebetween.

The pair of conveying rollers 17 and pair of discharging rollers 20 are rollers for conveying the sheet to which the toner images have been fixed by the fixing unit 12, to the discharged sheet tray 22, which is disposed at a top of the housing 2. The pair of conveying rollers 17 are pressed against each other with the conveyance path W therebetween. The pair of discharging rollers 20 are pressed against each other with the conveyance path W therebetween.

The front cover 3 is provided with an external sheet cassette 36. The external sheet cassette 36 is a portion for storing sheets, such as paper sheets. When the external sheet cassette 36 is not used, it is housed to be flush with the front cover 3. The sheet feed roller 15 is a roller for feeding a sheet from the external sheet cassette 36 to the conveyance path W.

Each of the sheet feed sensor 24A, writing sensor 24B, and discharge sensor 24C is a sheet detection sensor for detecting passage of a sheet, and mechanically operates in accordance with passage of a sheet and transmits the detection result to the controller 4. The sheet feed sensor 24A detects whether a sheet has passed through a point between the pair of conveying rollers 16 and the pair of registration rollers 18. The writing sensor 24B detects whether a sheet has passed through a point between the pair of registration rollers 18 and the nip portion of the intermediate transfer unit 10. The discharge sensor 24C detects whether a sheet has passed through a point between the fixing unit 12 and the pair of conveying rollers 17.

In printing, the image forming apparatus 1 conveys rearward a sheet fed from the sheet cassette 6 or external sheet cassette 36 to the nip portion of the intermediate transfer unit 10 and passes the sheet through the nip portion, thereby transferring toner images formed on the intermediate transfer belt 32 onto the sheet. Further, the image forming apparatus 1 conveys the sheet with the toner images transferred thereon to the fixing unit 12, and when passing the sheet through the fixing unit 12, heats and presses the sheet to fix the toner images to the sheet. Then, the image forming apparatus 1 discharges the sheet to the discharged sheet tray 22 through an outlet 2A.

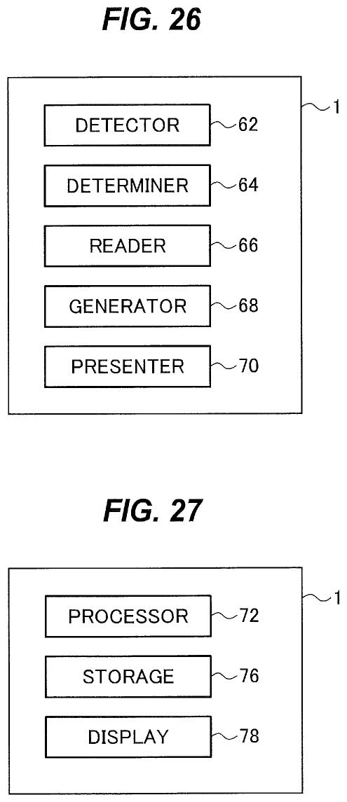

FIG. 26 is a block diagram illustrating a functional configuration of the image forming apparatus 1, and FIG. 27 is a block diagram illustrating a hardware configuration of the image forming apparatus 1.

In FIG. 26, the image forming apparatus 1 includes a detector 62, a determiner 64, a reader 66, a generator 68, and a presenter 70.

In FIG. 27, the image forming apparatus 1 includes processing circuitry 72. The image forming apparatus 1 may include a storage 76 and a display 78.

The functional blocks of FIG. 26 may be implemented by the processing circuitry 72. The processing circuitry 72 may be one or more processors that execute one or more programs stored in the storage 76 to implement the functional blocks of FIG. 26. However, the processing circuitry 72 may be implemented purely in hardware.

The detector 62 detects occurrences of multiple errors. The errors may be events each requiring a maintenance operation. For example, the errors each require a maintenance operation for removing the error. Examples of the errors (or events) include sheet jams at different locations that require maintenance operations for removing jammed sheets, and events in which consumables (such as the toner cartridges, the photosensitive drums, rollers, or belts) are used up or reach the ends of their lifetimes and that require maintenance operations for replacing the consumables.

The determiner 64 determines, on the basis of the detection by the detector 62, whether the multiple errors have occurred.

When the determiner 64 determines that the multiple errors have occurred, the reader 66 reads, for each of the multiple errors, a maintenance guide corresponding to the error and including multiple (or a series of) maintenance steps, from a storage (e.g., the storage 76). For example, the reader 66 reads, for each of the multiple errors, a maintenance guide for the maintenance operation for the error (or for guiding the maintenance operation for removing the error).

In a first aspect, the generator 66 generates a combined maintenance guide by combining (or arranging) the maintenance guides in a predetermined order while removing a duplicate (or redundant) maintenance step of the maintenance steps of the maintenance guides. For example, when the maintenance steps of the maintenance guides include two duplicate (or identical) maintenance steps, the generator 66 removes one of the duplicate maintenance steps.

In one example of the first aspect, the maintenance guides include a first maintenance guide and a second maintenance guide, and the generator 66 generates the combined maintenance guide by combining the maintenance guides in the predetermined order so that the first maintenance guide is followed by the second maintenance guide, removing the duplicate maintenance step, and adding, between the first maintenance guide and the second maintenance guide, a step of indicating that the second maintenance guide exists following the first maintenance guide (or that there remains another error).

In a second aspect, the maintenance guides include a first maintenance guide and a second maintenance guide, and the generator 66 generates a combined maintenance guide by combining (or arranging) the maintenance guides so that the first maintenance guide is followed by the second maintenance guide, and adding, between the first maintenance guide and the second maintenance guide, a step of indicating that the second maintenance guide exists following the first maintenance guide (or that there remains another error).

The presenter 70 displays the combined maintenance guide on the display 78 provided in the image forming apparatus 1.

The image forming apparatus 1 implements a maintenance guide generation method.

In a first aspect, the maintenance guide generation method includes: (a) detecting occurrences of multiple errors; (b) determining, on the basis of the detecting, whether the multiple errors have occurred; (c) when the determining determines that the multiple errors have occurred, reading, for each of the multiple errors, a maintenance guide corresponding to the error and including multiple (or a series of) maintenance steps; and (d) generating a combined maintenance guide by combining (or arranging) the maintenance guides in a predetermined order while removing a duplicate maintenance step of the maintenance steps of the maintenance guides.

In one example of the first aspect, the maintenance guides include a first maintenance guide and a second maintenance guide, and the generating generates the combined maintenance guide by combining the maintenance guides in the predetermined order so that the first maintenance guide is followed by the second maintenance guide, removing the duplicate maintenance step, and adding, between the first maintenance guide and the second maintenance guide, a step of indicating that the second maintenance guide exists following the first maintenance guide (or that there remains another error).

In another example of the first aspect, the generating generates the combined maintenance guide by connecting the maintenance guides in the predetermined order to generate a connected maintenance guide, and when the maintenance steps of the maintenance guides include duplicate maintenance steps, leaving the earliest or latest one of the duplicate maintenance steps in the connected maintenance guide and removing the other one or more of the duplicate maintenance steps from the connected maintenance guide.

In another example of the first aspect, the maintenance guides include a first maintenance guide and a second maintenance guide. The multiple maintenance steps of the first maintenance guide include a first maintenance step of changing an object from a first state to a second state and a second maintenance step of restoring the object from the second state to the first state. The multiple maintenance steps of the second maintenance guide include a first maintenance step of changing the object from the first state to the second state and a second maintenance step of restoring the object from the second state to the first state. The generating generates the combined maintenance guide by combining the maintenance guides in the predetermined order so that the first maintenance guide is prior to the second maintenance guide, and removing the second maintenance step of the first maintenance guide and the first maintenance step of the second maintenance guide. For example, the object is a cover (e.g., the front cover 3), the first state is a closed state, and the second state is an open state.

In a second aspect, the maintenance guide generation method includes: (a) detecting occurrences of multiple errors; (b) determining, on the basis of the detecting, whether the multiple errors have occurred; (c) when the determining determines that the multiple errors have occurred, reading, for each of the multiple errors, a maintenance guide corresponding to the error and including multiple (or a series of) maintenance steps, the maintenance guides including a first maintenance guide and a second maintenance guide; and (d) generating a combined maintenance guide by combining (or arranging) the maintenance guides so that the first maintenance guide is followed by the second maintenance guide, and adding, between the first maintenance guide and the second maintenance guide, a step of indicating that the second maintenance guide exists following the first maintenance guide (or that there remains another error).

In the first and second aspects, each maintenance guide may be for removing a jammed sheet from the image forming apparatus 1.

In the first and second aspects, the maintenance guide generation method may further include presenting the combined maintenance guide.

As above the image forming apparatus 1 (or the maintenance guide generation method) generates, when multiple errors occur (e.g., at different locations), a maintenance guide for the errors while removing a duplicate maintenance step, thereby preventing the user from redundantly performing the same maintenance operation. Thus, the image forming apparatus 1 (or the maintenance guide generation method) can generate a convenient maintenance guide.

Hereinafter, the image forming apparatus 1 will be described more specifically.

### <2. Control Configuration of Image Forming Apparatus>

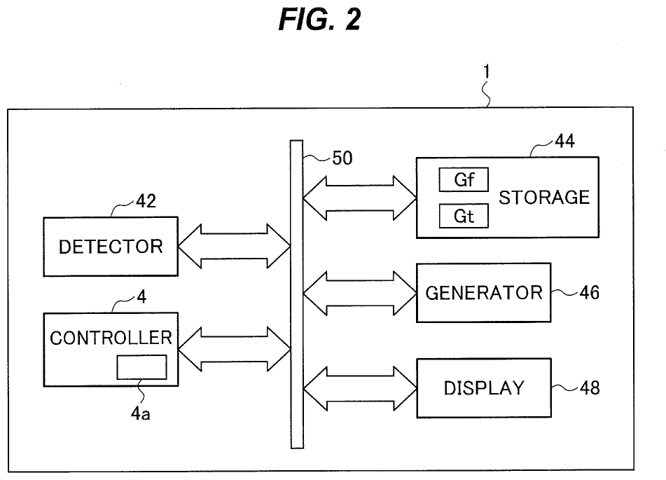

As illustrated in FIG. 2, in the image forming apparatus 1, the controller 4 is connected to various portions (specifically, a detector 42, a storage 44, a generator 46, and a display 48) through a bus 50, and entirely controls the image forming apparatus 1. The controller 4 includes a processor (e.g., a central processing unit (CPU)) 4a, and the controller 4 (or processor 4a) reads and executes predetermined programs from the storage 44, which includes a read only memory (ROM), a random access memory (RAM), a flash memory, or the like, thereby controlling various portions to perform various processes. The processor 4a, storage 44, and display 48 of FIG. 2 are examples of the processing circuitry 72, storage 76, and display 78 of FIG. 27, respectively.

The detector 42 includes the sheet feed sensor 24A, writing sensor 24B, and discharge sensor 24C, each of which detects whether a sheet has passed through the sensor and transmits the detection result to the controller 4. On the basis of the detection results from the detector 42, the controller 4 determines detection times of the sheet feed sensor 24A, writing sensor 24B, and discharge sensor 24C, and for example, when a sheet fails to pass through the writing sensor 24B within a predetermined time after passing through the sheet feed sensor 24A, detects that a jam has occurred. The jam is an event in which a sheet is stuck in the image forming apparatus 1 during printing.

The controller 4 can detect different jams, including a sheet feed jam and a conveyance jam. The sheet feed jam is a jam that occurs during feed of the sheet, and is, for example, an event in which a sheet fed from the sheet cassette 6 or external sheet cassette 36 fails to reach the writing sensor 24B. The sheet feed jam tends to occur near the pair of conveying rollers 16. The conveyance jam is a jam that occurs during image formation on the sheet, and is, for example, an event in which a sheet that has passed through the writing sensor 24B fails to reach the discharge sensor 24C. The conveyance jam tends to occur near the secondary transfer roller 34 and secondary transfer backup roller 35.

The controller 4 can also detect that multiple jams (e.g., both a sheet feed jam and a conveyance jam) have occurred, on the basis of the detection results from multiple sensors of the sheet feed sensor 24A, writing sensor 24B, and discharge sensor 24C. Hereinafter, a jam (e.g., each of the sheet feed jam and conveyance jam) occurring at one location in the image forming apparatus 1 will be referred to as a single jam, and an event in which multiple jams (e.g., the sheet feed jam and conveyance jam) occur simultaneously will be referred to as a multiple jam.

The storage 44 stores jam removal guide information that is information indicating jam removal guides. The jam removal guides include, for example, a sheet feed jam removal guide Gf that is a guide for removing a sheet feed jam, and a conveyance jam removal guide Gt that is a guide for removing a conveyance jam. For each of the locations where a jam can occur, a jam removal guide is prepared. Each jam removal guide includes steps for removing a jam. Each jam removal guide includes a guide screen (or image) for each step of the jam removal guide. Each guide screen represents an instruction with texts and photographs. The jam removal guides (including the sheet feed jam removal guide Gf and conveyance jam removal guide Gt) are each a single jam removal guide. As such, a single jam removal guide is prepared for each of the locations where a jam can occur. Thus, the storage 44 stores multiple single jam removal guides.

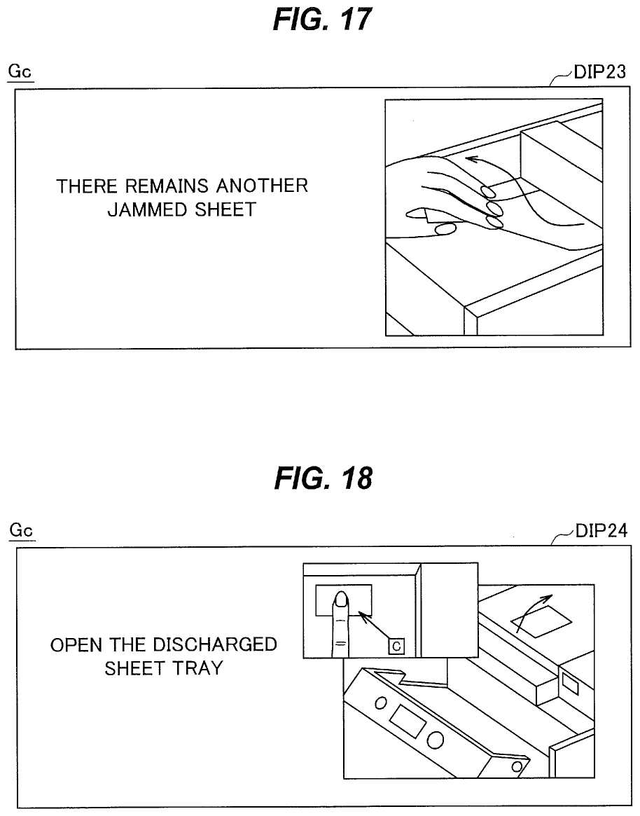

The storage 44 also stores, in the jam removal guide information, a screen (e.g., a following guide indicating screen DIP23 (see FIG. 17)) for indicating, after a jam (e.g., a sheet feed jam) is removed, to the user that there remains another jam (e.g., a conveyance jam).

When the controller 4 detects that a sheet feed jam has occurred alone, it reads the sheet feed jam removal guide Gf from the jam removal guide information of the storage 44 and sequentially displays the guide screens included in the sheet feed jam removal guide Gf on the display 48, thereby presenting the steps for removing the sheet feed jam to the user and assisting the user in removing the jam.

When the controller 4 detects that a conveyance jam has occurred alone, it reads the conveyance jam removal guide Gt from the jam removal guide information of the storage 44 and sequentially displays the guide screens included in the conveyance jam removal guide Gt on the display 48, thereby presenting the steps for removing the conveyance jam to the user and assisting the user in removing the jam.

On the other hand, when the controller 4 detects that a sheet feed jam and a conveyance jam have occurred simultaneously, it reads the sheet feed jam removal guide Gf and conveyance jam removal guide Gt from the jam removal guide information of the storage 44, generates a multiple jam removal guide with the generator 46 by combining the guide screens included in the sheet feed jam removal guide Gf and the guide screens included in the conveyance jam removal guide Gt, and displays the multiple jam removal guide on the display 48, thereby presenting steps for removing the sheet feed jam and conveyance jam to the user and assisting the user in removing the jams. This will be described later. When combining the guide screens, the controller 4 may select guide screens from among the guide screens and arrange the selected guide screens as needed.

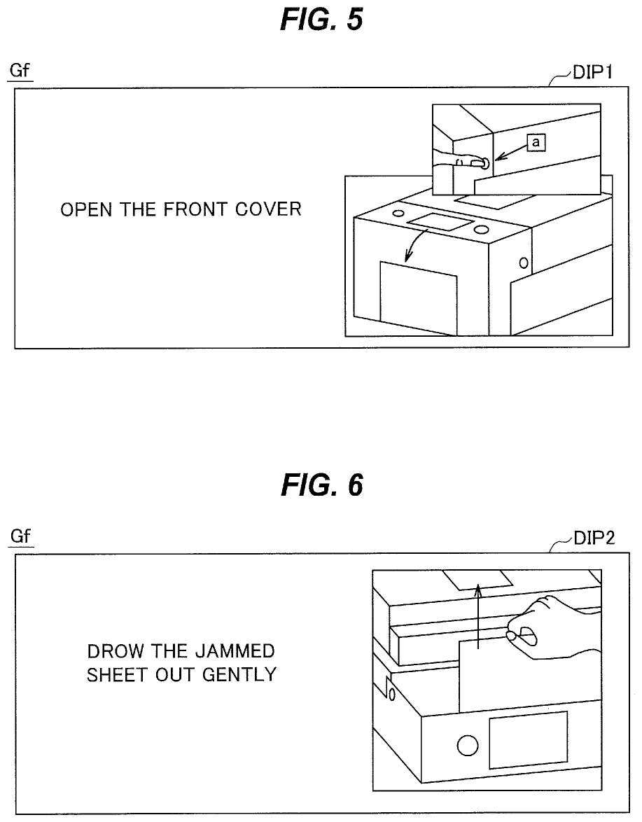

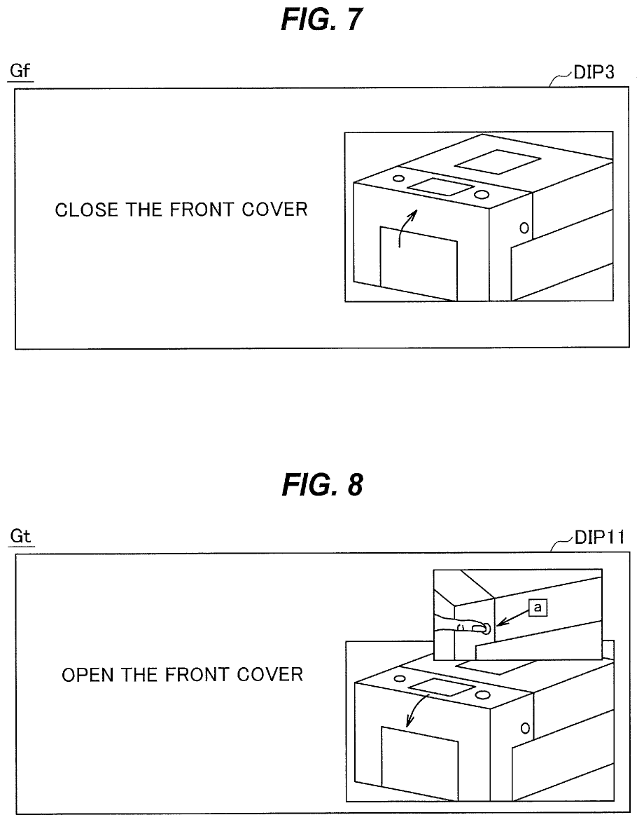

The sheet feed jam removal guide Gf causes the display 48 to sequentially display three guide screens: a front cover opening instruction screen DIP1 (see FIG. 5) representing maintenance step A, a jammed sheet drawing instruction screen DIP2 (see FIG. 6) representing maintenance step B, and a front cover closing instruction screen DIP3 (see FIG. 7) representing maintenance step C, for example.

The front cover opening instruction screen DIP1 (see FIG. 5) instructs the user to open the front cover 3 toward the user. The jammed sheet drawing instruction screen DIP2 (see FIG. 6) instructs the user to draw out a sheet jammed near the pair of conveying rollers 16 and pair of registration rollers 18 in the image forming apparatus 1 in the state where the front cover 3 is opened. The front cover closing instruction screen DIP3 (see FIG. 7) instructs the user to close the front cover 3 in the state where the jammed sheet has been drawn out of the image forming apparatus 1.

When the image forming apparatus 1 detects that a sheet feed jam, which is a single jam, has occurred alone, it displays the sheet feed jam removal guide Gf on the display 48, thereby presenting the steps for removing the sheet feed jam to the user one by one in a step-by-step manner and assisting the user in removing the jam.

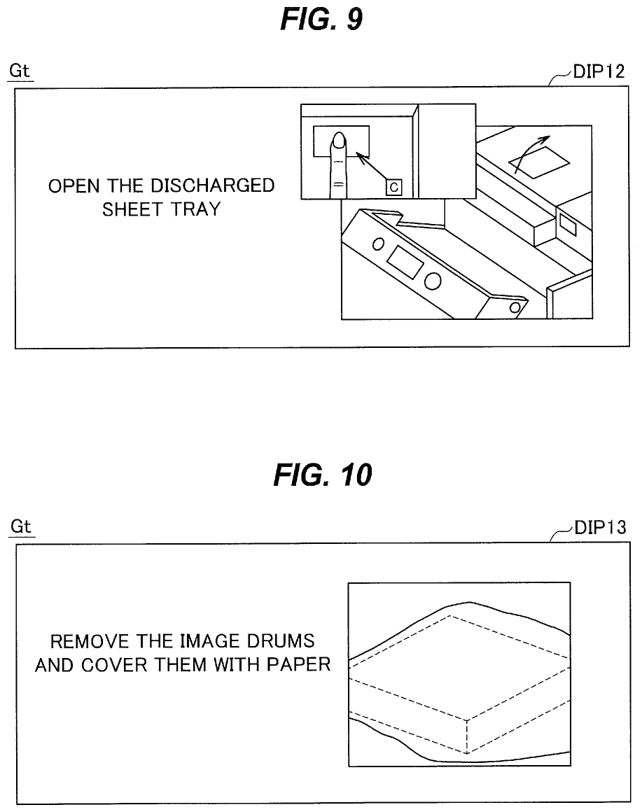

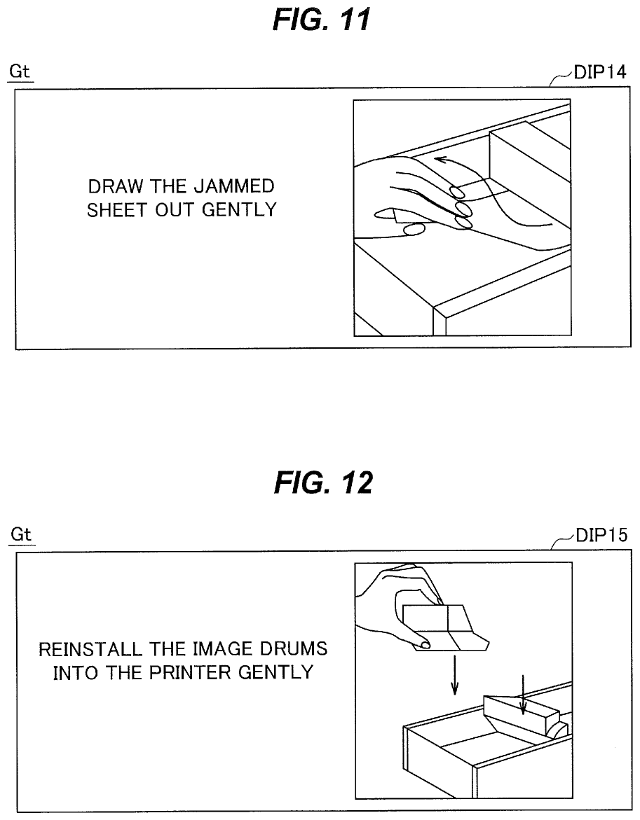

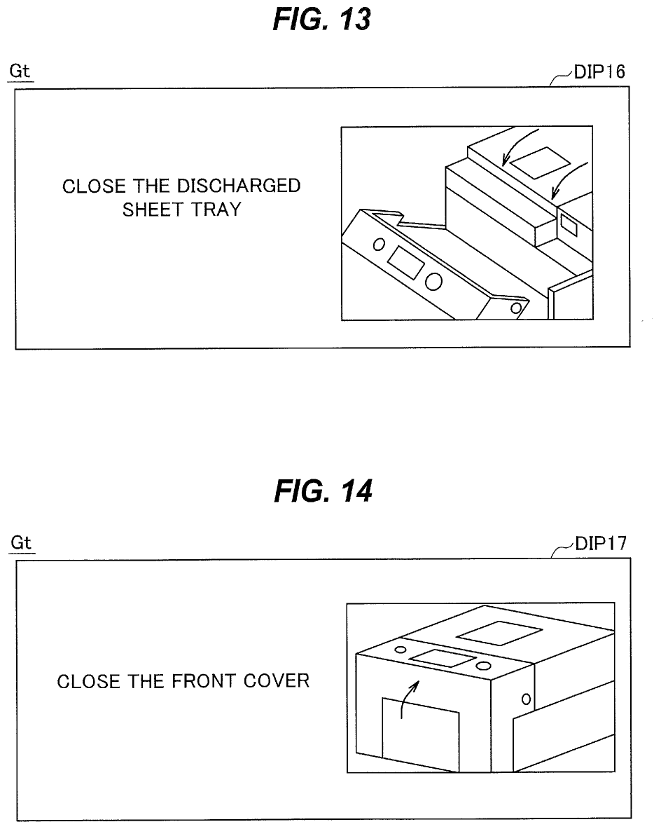

The conveyance jam removal guide Gt causes the display 48 to sequentially display seven guide screens: a front cover opening instruction screen DIP11 (see FIG. 8) representing maintenance step A, a discharged sheet tray opening instruction screen DIP12 (see FIG. 9) representing maintenance step D, an image drum removing instruction screen DIP13 (see FIG. 10) representing maintenance step E, a jammed sheet drawing instruction screen DIP14 (see FIG. 11) representing maintenance step F, an image drum reinstalling instruction screen DIP15 (see FIG. 12) representing maintenance step G, a discharged sheet tray closing instruction screen DIP16 (see FIG. 13) representing maintenance step H, and a front cover closing instruction screen DIP17 (see FIG. 14) representing maintenance step C, for example.

The front cover opening instruction screen DIP11 (see FIG. 8) instructs the user to open the front cover 3 toward the user, as with the front cover opening instruction screen DIP1 (see FIG. 5). The discharged sheet tray opening instruction screen DIP12 (see FIG. 9) instructs the user to open the discharged sheet tray 22 upward in the state where the front cover 3 is opened. The image drum removing instruction screen DIP13 (see FIG. 10) instructs the user to remove the image forming units 8 and cover them with paper in the state where the discharged sheet tray 22 is opened. The jammed sheet drawing instruction screen DIP14 (see FIG. 11) instructs the user to draw out a sheet jammed near the secondary transfer roller 34 and secondary transfer backup roller 35 in the image forming apparatus 1 in the state where the image forming units 8 have been removed. The image drum reinstalling instruction screen DIP15 (see FIG. 12) instructs the user to install the image forming units 8 in the state where the jammed sheet has been drawn out of the image forming apparatus 1. The discharged sheet tray closing instruction screen DIP16 (see FIG. 13) instructs the user to close the discharged sheet tray 22 in the state where the image forming units 8 have been installed. The front cover closing instruction screen DIP17 (see FIG. 14) instructs the user to close the front cover 3 in the state where the discharged sheet tray 22 is closed, as with the front cover closing instruction screen DIP3 (see FIG. 7).

When the image forming apparatus 1 detects that a conveyance jam, which is a single jam, has occurred alone, it displays the conveyance jam removal guide Gt on the display 48, thereby presenting the steps for removing the conveyance jam to the user one by one in a step-by-step manner and assisting the user in removing the jam.

On the basis of a detection result from the controller 4, when a multiple jam has occurred, the generator 46 (see FIG. 2) generates a multiple jam removal guide on the basis of the single jam removal guides stored in the storage 44.

The display 48 (see FIG. 2), which is, for example, a liquid crystal display (LCD), displays various screens or the like under control of the controller 4. The display 48 displays the multiple jam removal guide generated by the generator 46.

### <3. Functional Configuration of Image Forming Apparatus>

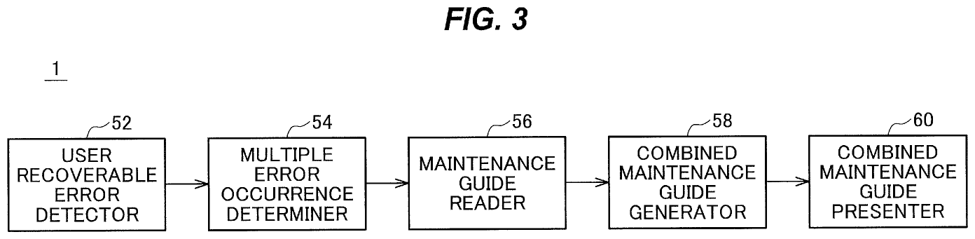

FIG. 3 is a functional block diagram illustrating basic functions relating to a jam removal guide display process (to be described later) of the image forming apparatus 1. The controller 4 (see FIG. 2) of the image forming apparatus 1 executes a jam removal guide display process program, thereby implementing functional blocks: a user recoverable error detector (or detector) 52, a multiple error occurrence determiner (or determiner) 54, a maintenance guide reader (or reader) 56, a combined maintenance guide generator (or generator) 58, and a combined maintenance guide presenter (or presenter) 60. The detector 52, determiner 54, reader 56, generator 58, and presenter 60 are examples of the detector 62, determiner 64, reader 66, generator 68, and presenter 70 of FIG. 26, respectively.

The detector 52 corresponds to the controller 4 and detector 42. The detector 52 detects occurrences of errors that are events requiring maintenance operations. For example, the detector 52 detects occurrences of jams as errors requiring jam removal operations as maintenance operations. Also, when an error occurs, the detector 52 determines whether the error is an error that can be recovered by the user or an error (referred to as a serviceman call error) that cannot be recovered by the user. When the detector 52 determines that the error is an error that can be recovered by the user, the image forming apparatus 1 reads, from the storage 44, maintenance guide information (e.g., the jam removal guide information) indicating maintenance guides (e.g., the jam removal guides), and presents it to the user, thereby guiding a recovery process or maintenance operation.

The determiner 54 corresponds to the controller 4. The determiner 54 determines, on the basis of the detection by the detector 52, whether multiple errors have occurred.

The reader 56 corresponds to the controller 4. When the determiner 54 determines that multiple errors have occurred, the reader 56 reads, from the storage 44, for each of the locations where the maintenance operations corresponding to the respective errors are to be performed, a maintenance guide including multiple maintenance steps. For example, when the determiner 54 determines that a sheet feed jam and a conveyance jam have occurred, the reader 56 reads, from the storage 44, the sheet feed jam removal guide Gf and conveyance jam removal guide Gt as the maintenance guides.

The generator 58 corresponds to the controller 4 and generator 46. The generator 58 generates a combined maintenance guide (e.g., a multiple jam removal guide) by combining (or arranging) the multiple maintenance guides read by the reader 56 in a predetermined order while removing duplicate maintenance steps.

The presenter 60 corresponds to the controller 4 and display 48. The presenter 60 presents the combined maintenance guide generated by the generator 58 to the user.

### <4. Jam Removal Guide Display Process>

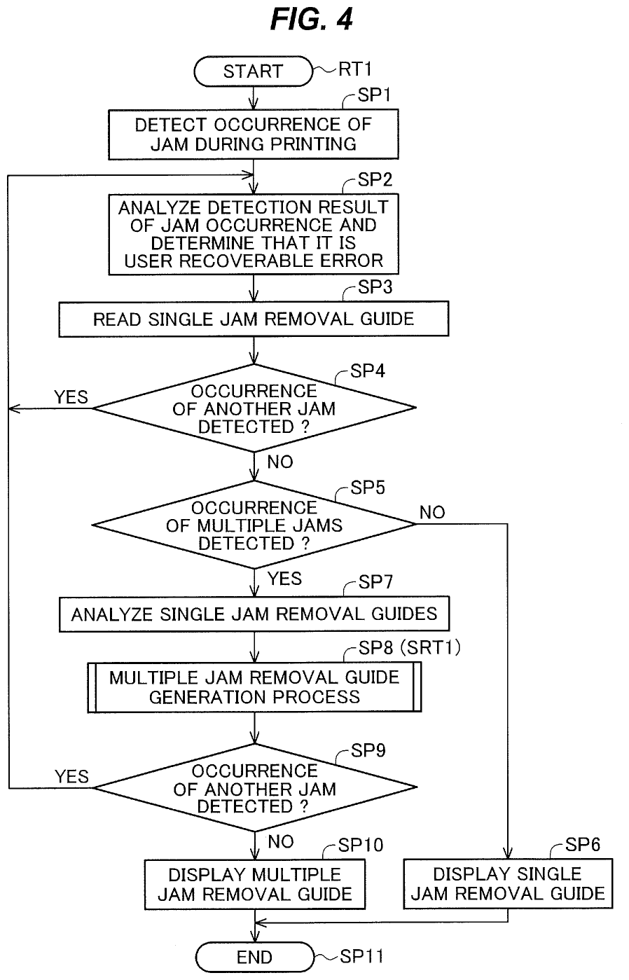

Next, a specific procedure of the jam removal guide display process by the image forming apparatus 1 will be described in detail with reference to the flowchart illustrated in FIG. 4.

The controller 4 starts the jam removal guide display process RT1 and proceeds to step SP1. In step SP1, on the basis of the detection result from the detector 42, the controller 4 detects, with the detector 52, that a jam has occurred during printing, and proceeds to step SP2.

In step SP2, the controller 4 determines the location of occurrence of the jam (or where the jam has occurred) and how the jam has occurred, by the detector 52 analyzing the detection result, determines the type of the jam from the determination, and when the jam is an error that can be recovered by the user, proceeds to step SP3.

In step SP3, on the basis of the determination in step SP2, the controller 4 reads, with the reader 56, from the jam removal guide information of the storage 44, the single jam removal guide corresponding to the type of the jam (i.e., for removing the jam), and proceeds to step SP4.

In step SP4, the controller 4 determines, with the determiner 54, whether the detector 42 has detected an occurrence of another jam other than the jam(s) for which the single jam removal guide has been read in step SP3. When the determination is negative, it means that only one jam at one location has been detected, and the controller 4 proceeds to step SP5.

On the other hand, when the determination in step SP4 is positive, it means that the detection result of the other jam needs to be analyzed. At this time, the controller 4 returns to step SP2, in which the controller 4 analyzes the detection result of the other jam, and proceeds to step SP3, in which the controller 4 reads, from the jam removal guide information of the storage 44, the single jam removal guide for removing the other jam, on the basis of the analysis in step SP2, and proceeds to step SP4.

The controller 4 reads all the single jam removal guides corresponding to single jams that have occurred, by repeating steps SP2 to SP4 in this manner, and proceeds to step SP5.

In step SP5, the controller 4 determines, with the determiner 54, whether occurrences of multiple single jams have been detected. When the determination is negative, it means that a jam has occurred at only one location and thus it is sufficient to display, on the display 48, the single jam removal guide corresponding to the jam. At this time, the controller 4 proceeds to step SP6.

In step SP6, the controller 4 displays, on the display 48, the single jam removal guide read in step SP3, and proceeds to step SP11, ending the jam removal guide display process RT1. As such, for example, when the controller 4 detects only a sheet feed jam, the controller 4 reads the sheet feed jam removal guide Gf (see FIG. 2), which is a single jam removal guide, from the storage 44, and displays it on the display 48. For example, when the controller 4 detects only a conveyance jam, the controller 4 reads the conveyance jam removal guide Gt (see FIG. 2), which is a single jam removal guide, from the storage 44, and displays it on the display 48.

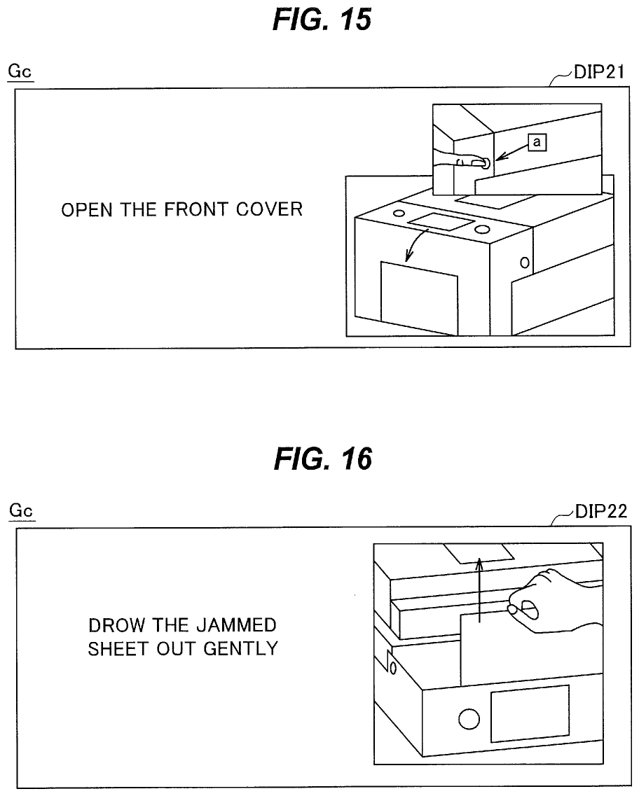

On the other hand, when the determination in step SP5 is positive, it means that jams have occurred at multiple locations and thus it is required to generate a multiple jam removal guide Gc (see FIGS. 15 to 23) by combining the single jam removal guides corresponding to the respective jams and display it on the display 48. At this time, the controller 4 proceeds to step SP7.

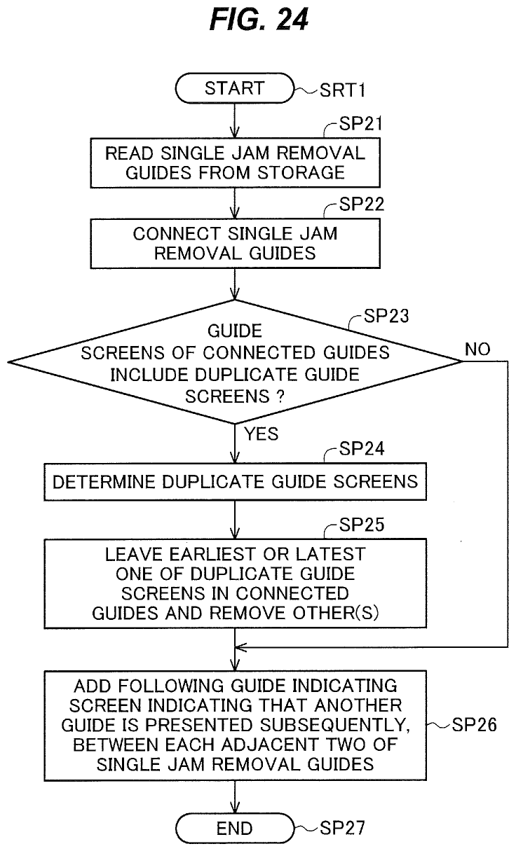

In step SP7, the controller 4 analyzes, with the generator 58, the single jam removal guides to perform analysis on all the locations where the jams have occurred, determines an order in which the jams are easily removed along a sheet traveling path, on the basis of the locations where the jams have occurred and how the jams have occurred, and determines at which of the maintenance steps a member (e.g., the front cover 3) is opened and closed. Then, the controller 4 proceeds to step SP8, in which the controller 4 generates, with the generator 58, a multiple jam removal guide Gc through a multiple jam removal guide generation process SRT1 illustrated in FIG. 24, and proceeds to step SP9.

In step SP9, similarly to step SP4, the controller 4 determines, with the determiner 54, whether the detector 42 has detected an occurrence of another jam other than the jams to be removed by the multiple jam removal guide Gc. When the determination is positive, it means that another jam has newly occurred during the generation of the multiple jam removal guide Gc. At this time, the controller 4 returns to step SP2 and repeats the above-described process. On the other hand, when the determination in step SP9 is negative, the controller 4 proceeds to step SP10.

In step SP10, the controller 4 displays, with the presenter 60, the generated multiple jam removal guide Gc on the display 48, and proceeds to step SP11, ending the jam removal guide display process RT1.

### <5. Multiple Jam Removal Guide Generation Process>

Next, a specific procedure of the multiple jam removal guide generation process by the image forming apparatus 1 will be described with reference to the flowchart of FIG. 24. In step SP8 of the jam removal guide display process RT1 (see FIG. 4), the controller 4 starts the multiple jam removal guide generation process SRT1 illustrated in FIG. 24, and proceeds to step SP21.

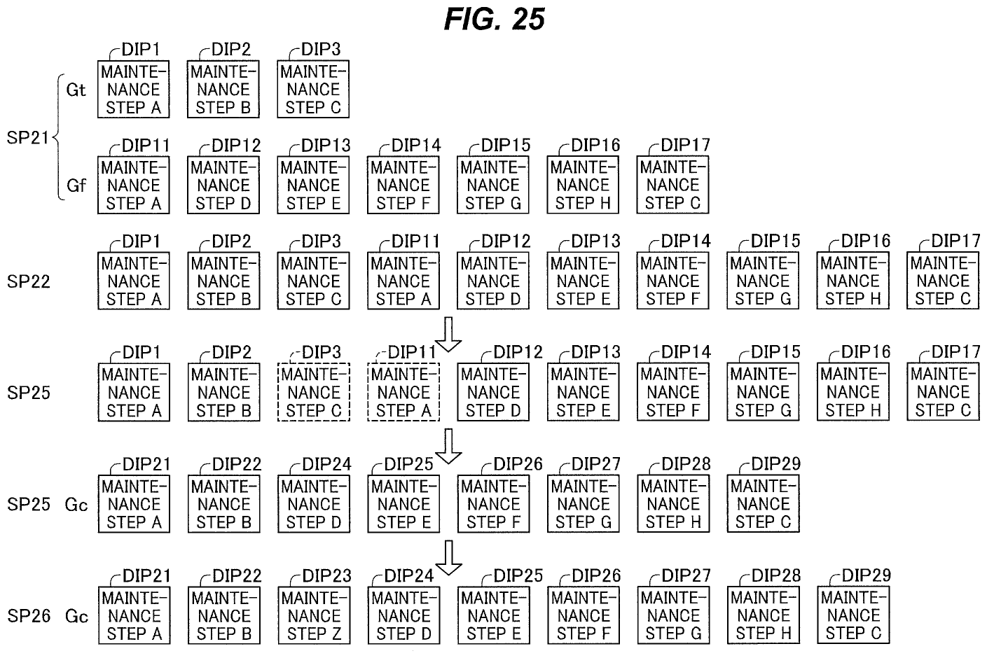

In step SP21, the controller 4 reads, from the storage 44, the single jam removal guides for the detected jams. For example, when a sheet feed jam and a conveyance jam have occurred, the controller 4 reads the sheet feed jam removal guide Gf and conveyance jam removal guide Gt, as illustrated in FIG. 25. Then, the controller 4 proceeds to step SP22.

In step SP22, the controller 4 connects the single jam removal guides in a predetermined order, and proceeds to step SP23. Specifically, on the basis of the analyses and the determinations, the controller 4 arranges the single jam removal guides in a predetermined order such that the user can easily remove the jams or in an order such that the user can easily remove the jams from a upstream side toward a downstream side in the sheet conveying direction (or in order from the jam closest to the sheet cassette 6 or external sheet cassette 36). For example, the controller 4 connects the sheet feed jam removal guide Gf and conveyance jam removal guide Gt, which are single jam removal guides, as illustrated in FIG. 25.

As such, the controller 4 connects the single jam removal guides so that the jams are removed in order from the upstream side toward the downstream side in the sheet conveying direction, for example. For example, since the conveyance jam occurs closer to the outlet 2A than the sheet feed jam in the sheet conveying direction (or the conveyance jam occurs downstream of the sheet feed jam in the sheet conveying direction), the controller 4 connects the single jam removal guides so that the sheet feed jam is removed earlier than the conveyance jam. Thus, the image forming apparatus 1 can allow the user to remove the jams in order from the sheet feed side, which is easy to access from the outside, to the sheet discharge side, and allow the user to easily understand how to remove the jams. However, the controller 4 may connect the single jam removal guides so that the jams are removed in order from the downstream side toward the upstream side in the sheet conveying direction. For example, the controller 4 may connect the single jam removal guides so that the conveyance jam is removed earlier than the sheet feed jam. This is useful, for example, when the sheet discharge side is easy to access from the outside. In addition, when the jams include a special jam, the controller 4 connects the single jam removal guides so that the special jam is removed preferentially (or first).

In step SP23, the controller 4 determines whether the guide screens of the connected single jam removal guides include duplicate guide screens. When the determination is positive, the controller 4 proceeds to step SP24. On the other hand, when the determination in step SP23 is negative, the controller 4 skips steps SP24 and SP25, and proceeds to step SP26.

In step SP24, the controller 4 determines the duplicate guide screens, and proceeds to step SP25. Specifically, the controller 4 determines that the front cover opening instruction screen DIP1 (see FIG. 5) of the sheet feed jam removal guide Gf and the front cover opening instruction screen DIP11 (see FIG. 8) of the conveyance jam removal guide Gt represent maintenance step A, the same maintenance step, and are duplicate guide screens. Also, the controller 4 determines that the front cover closing instruction screen DIP3 (see FIG. 7) of the sheet feed jam removal guide Gf and the front cover closing instruction screen DIP17 (see FIG. 14) of the conveyance jam removal guide Gt represent maintenance step C, the same maintenance step, and are duplicate guide screens.

In step SP25, the controller 4 leaves the earliest or latest one of the duplicate guide screens in the connected single jam removal guides and removes the other(s) of the duplicate guide screens from the connected single jam removal guides, and proceeds to step SP26. When the connected single jam removal guides include multiple sets of duplicate guide screens, the above processing in step SP25 is performed for each set. For example, as illustrated in FIG. 25, since the front cover opening instruction screen DIP1 (see FIG. 5) of the sheet feed jam removal guide Gf and the front cover opening instruction screen DIP11 (see FIG. 8) of the conveyance jam removal guide Gt are the same in content and are duplicate guide screens, the controller 4 leaves the front cover opening instruction screen DIP1 (see FIG. 5), which is earlier than the front cover opening instruction screen DIP11 (see FIG. 8), in the connected single jam removal guides, and removes the front cover opening instruction screen DIP11 (see FIG. 8). Also, since the front cover closing instruction screen DIP3 (see FIG. 7) of the sheet feed jam removal guide Gf and the front cover closing instruction screen DIP17 (see FIG. 14) of the conveyance jam removal guide Gt are the same in content and are duplicate guide screens, the controller 4 leaves the front cover closing instruction screen DIP17 (see FIG. 14), which is later than the front cover closing instruction screen DIP3 (see FIG. 7), in the connected single jam removal guides, and removes the front cover closing instruction screen DIP3 (see FIG. 7). Thus, when a guide screen of the sheet feed jam removal guide Gf and a guide screen of the conveyance jam removal guide Gt represent the same operation, such as an operation of opening the front cover 3 and an operation of closing the front cover 3, the controller 4 removes one of the guide screens.

In step SP26, the controller 4 adds or inserts a following guide indicating screen DIP23 (see FIG. 17) between each adjacent two of the single jam removal guides. The following guide indicating screen DIP23 represents maintenance step Z of indicating that another guide is presented subsequently. For example, as illustrated in FIG. 25, the controller 4 adds a following guide indicating screen DIP23 (see FIG. 17) so that the screen DIP23 is displayed immediately after removal of the sheet feed jam. The following guide indicating screen DIP23 represents a following guide indicating step of indicating, after removal of the sheet feed jam, to the user that although the sheet feed jam has been removed, the conveyance jam has not yet been removed and a guide for removing the conveyance jam is presented subsequently. Specifically, the controller 4 adds the following guide indicating screen DIP23 (see FIG. 17) between a jammed sheet drawing instruction screen DIP22 (see FIG. 16) and a discharged sheet tray opening instruction screen DIP24 (see FIG. 18) in the multiple jam removal guide Gc. Then, the controller 4 proceeds to step SP27, ends the multiple jam removal guide generation process SRT1, and proceeds to step SP9 of the jam removal guide display process RT1 (see FIG. 4).

As above, when multiple jams occur substantially simultaneously, the controller 4 reads the single jam removal guides for the respective jams. The controller 4 then arranges the guides in a predetermined order such that the jams can be easily removed, or an order such that the jams can be easily removed in order from the upstream side (or sheet feed side) toward the downstream side (or sheet discharge side) in the sheet conveying direction, for example. The controller 4 then checks the arranged guides for maintenance steps indicating the same operation, determines whether some of the maintenance steps can be removed. When it is determined that some of the maintenance steps can be removed, the controller 4 leaves the earliest or latest one of the maintenance steps in the arranged guides and removes the other(s) of the maintenance steps so that the number of maintenance steps indicating the same operation is one. Further, the controller 4 adds a following guide indicating screen DIP23 (see FIG. 17) indicating that there is a subsequent guide, between each adjacent two of the arranged guides.

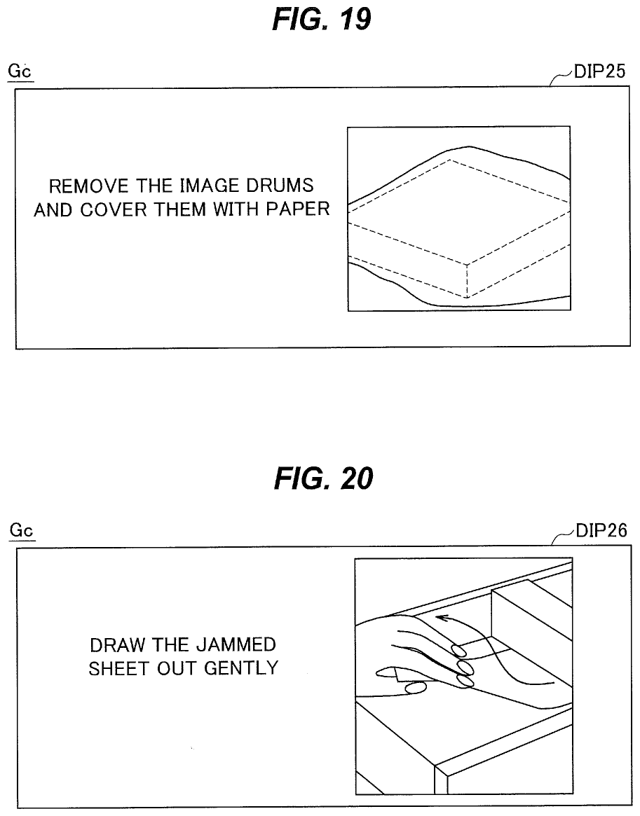

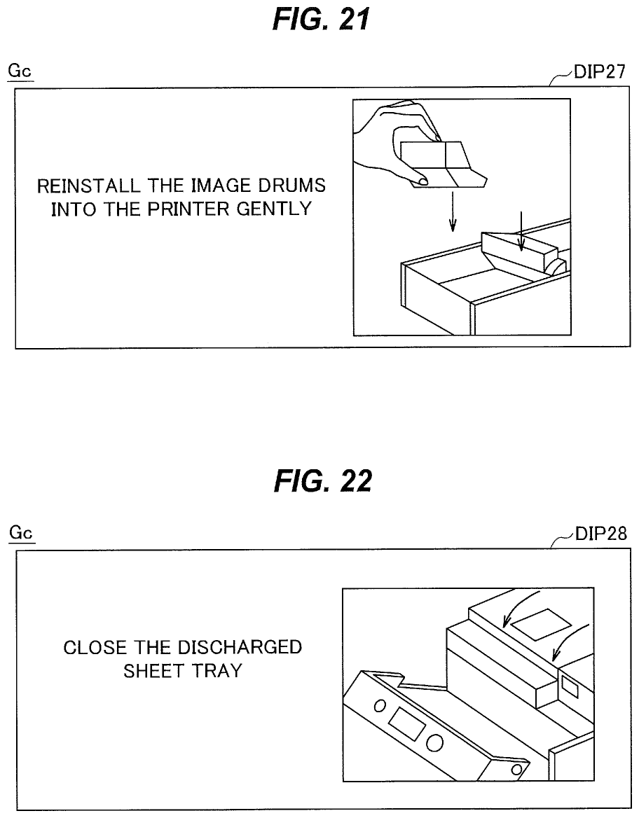

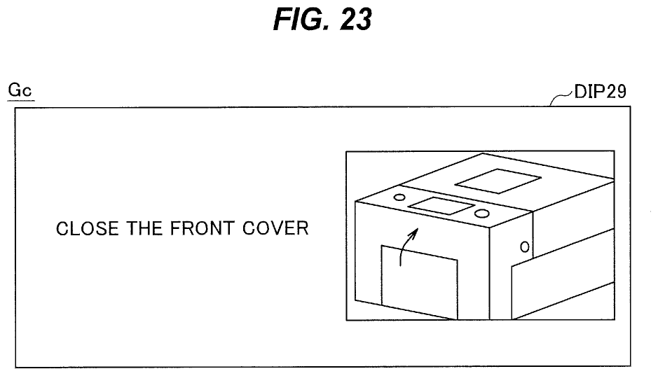

In this manner, the controller 4 generates, for example, a multiple jam removal guide Gc illustrated in FIGS. 15 to 23. The multiple jam removal guide Gc illustrated in FIGS. 15 to 23 causes the display 48 to sequentially display nine guide screens: a front cover opening instruction screen DIP21 (see FIG. 15), a jammed sheet drawing instruction screen DIP22 (see FIG. 16), a following guide indicating screen DIP23 (see FIG. 17), a discharged sheet tray opening instruction screen DIP24 (see FIG. 18), an image drum removing instruction screen DIP25 (see FIG. 19), a jammed sheet drawing instruction screen DIP26 (see FIG. 20), an image drum reinstalling instruction screen DIP27 (see FIG. 21), a discharged sheet tray closing instruction screen DIP28 (see FIG. 22), and a front cover closing instruction screen DIP29 (see FIG. 23), for example.

The front cover opening instruction screen DIP21 (see FIG. 15) is the same as the front cover opening instruction screen DIP1 (see FIG. 5). The jammed sheet drawing instruction screen DIP22 (see FIG. 16) is the same as the jammed sheet drawing instruction screen DIP2 (see FIG. 6). Thus, the controller 4 indicates maintenance step A, which is the first step common to the sheet feed jam removal guide Gf and conveyance jam removal guide Gt, of opening the front cover 3 toward the user.

The following guide indicating screen DIP23 (see FIG. 17) indicates to the user that not only a sheet feed jam but also a conveyance jam has occurred, and that although the sheet feed jam has been removed, the conveyance jam has not yet been removed, and this is followed by a guide for removing the conveyance jam. Thus, the controller 4 reads the following guide indicating screen DIP23 (see FIG. 17) from the storage 44 and adds it immediately before the step of closing the front cover 3, i.e., immediately after the step of removing the sheet feed jam in the sheet feed jam removal guide Gf.

The discharged sheet tray opening instruction screen DIP24 (see FIG. 18), image drum removing instruction screen DIP25 (see FIG. 19), jammed sheet drawing instruction screen DIP26 (see FIG. 20), image drum reinstalling instruction screen DIP27 (see FIG. 21), and discharged sheet tray closing instruction screen DIP28 (see FIG. 22) are the same as the discharged sheet tray opening instruction screen DIP12 (see FIG. 9), image drum removing instruction screen DIP13 (see FIG. 10), jammed sheet drawing instruction screen DIP14 (see FIG. 11), image drum reinstalling instruction screen DIP15 (see FIG. 12), and discharged sheet tray closing instruction screen DIP16 (see FIG. 13), respectively.

The front cover closing instruction screen DIP29 (see FIG. 23) is the same as the front cover closing instruction screen DIP17 (see FIG. 14). Thus, the controller 4 indicates maintenance step C, which is the last step common to the sheet feed jam removal guide Gf and conveyance jam removal guide Gt, of closing the front cover 3.

As above, when the controller 4 detects, for example, both a sheet feed jam and a conveyance jam simultaneously, the controller 4 reads, from the storage 44, the sheet feed jam removal guide Gf and conveyance jam removal guide Gt, which are single jam removal guides; generates a multiple jam removal guide Gc by arranging the guides in an order that allows the user to easily remove the jams along the sheet traveling path, removing one of guide screens indicating the same operation, and adding the following guide indicating screen DIP23 (see FIG. 17); and displays the multiple jam removal guide Gc on the display 48.

### <6. Advantages>

When multiple jams occur at different locations, a conventional image forming apparatus displays a single jam removal guide separately for each jam. In the conventional image forming apparatus, after the user opens a cover of the image forming apparatus, draws out a jammed sheet, and closes the cover in accordance with a single jam removal guide, another single jam removal guide for another jam is displayed. Thus, in the conventional image forming apparatus, the user may be forced to perform a troublesome operation, and may be confused by being informed, after removal of a jam, of another jam.

On the other hand, the image forming apparatus 1 generates a multiple jam removal guide Gc by combining jam removal guides in a predetermined order while removing one of guide screens representing duplicate maintenance steps. This can prevent the user from redundantly performing (or duplicating) the same operation, such as opening and closing a member, such as the front cover 3, and omit duplicate operations.

Further, when the image forming apparatus 1 detects that jams requiring jam removal operations have occurred at multiple locations, it reads, from the storage 44, the single jam removal guide representing the maintenance steps for each of the locations where the respective jam removal operations are to be performed, generates a multiple jam removal guide Gc by adding, between one of the single jam removal guides and another of the single jam removal guides following the one single jam removal guide, a following guide indicating screen DIP23 (see FIG. 17) indicating that the one single jam removal guide is followed by the other single jam removal guide, and displays the multiple jam removal guide Gc on the display 48. Thus, the image forming apparatus 1 generates a multiple jam removal guide Gc by adding, between at least part of one of the maintenance guides and at least part of another of the maintenance guides, a following guide indicating screen 23 (see FIG. 17) indicating that the one maintenance guide is followed by the other maintenance guide, and presents the multiple jam removal guide Gc to the user.

Thus, when jams occur at multiple locations in the image forming apparatus 1, the image forming apparatus 1 can display the guide corresponding to one of the jams to be removed first, and after the jam is removed by the user, display that there remains a location where a jam is to be removed next, and allow the user to continuously remove the jam at the next location.

Thus, when multiple jams occur, the image forming apparatus 1 can allow the user to remove all the jams at once without forcing the user to perform troublesome operation, and prevent the user from being confused by being informed, after removal of a jam, of the occurrence of another jam.

Further, the image forming apparatus 1 generates a multiple jam removal guide Gc so that a removal guide for a jam that has occurred at an upstream location in the sheet conveying direction is displayed earlier than a removal guide for a jam that has occurred at a downstream location in the sheet conveying direction. Thus, the image forming apparatus 1 can allow the user to remove the jams in an order from the upstream side toward the downstream side along the sheet conveying path, which is an order in which the user can easily remove the jammed sheets, thereby improving user-friendliness.

Further, the image forming apparatus 1 generates a multiple jam removal guide Gc from multiple single jam removal guides. Thus, the image forming apparatus 1 can present the multiple jam removal guide Gc to the user without previously storing the multiple jam removal guide Gc in the storage 44. This can reduce the capacity of the storage 44 or eliminate the need to newly extend the capacity of the storage 44.

### <7. Modifications>

The above embodiment describes generating a multiple jam removal guide Gc for guiding a jam removal operation as a maintenance operation. However, other types of combined maintenance guides may be generated. For example, when consumables, such as rollers, belts, or toner cartridges, provided in the image forming apparatus 1 are used up or reach the ends of their lifetimes, the errors are displayed, and the consumables need to be replaced, a combined maintenance guide for guiding a maintenance operation for replacing the consumables may be generated.

Further, the above embodiment describes displaying the multiple jam removal guide Gc on the display 48 of the image forming apparatus 1. However, the multiple jam removal guide Gc may be displayed on other displays. It is possible to display the multiple jam removal guide Gc on various displays, such as drivers installed in personal computers (PCs), or portable terminals, such as smartphones, tablets, or personal digital assistants (PDAs), other than the image forming apparatus 1. It is also possible to present to the user the multiple jam removal guide Gc by various means, such as sound or vibration.

Further, the above embodiment describes storing the jam removal guide information in the storage 44 of the image forming apparatus 1. However, the jam removal guide information may be stored in other storages. The jam removal guide information may be stored in storages of various external devices other than the image forming apparatus 1, and the image forming apparatus 1 may read the jam removal guide information from a storage of an external device.

Further, the above embodiment describes a case where the multiple jam removal guide Gc is generated by the generator 46 of the image forming apparatus 1. However, this is not mandatory, and the multiple jam removal guide Gc may be generated by various external devices other than the image forming apparatus 1.

Further, the above embodiment describes a case where the present invention is applied to a printer. However, the present invention is also applicable to various devices, such as copiers, multi-function peripherals, or facsimile machines.

Further, the above embodiment describes a case where the image forming apparatus 1 is constituted by the user recoverable error detector 52 as a detector, the multiple error occurrence determiner 54 as a determiner, the maintenance guide reader 56 as a reader, and the combined maintenance guide generator 58 as a generator. However, this is not mandatory, and an image forming apparatus may be constituted by a detector, a determiner, a reader, and a generator that have other configurations.

The present invention can also be used in various electronic devices, such as computers that cause printers to print images, image scanners, facsimile machines, and copiers, that perform various types of processing relevant to images.

The present invention is not limited to the embodiment and modifications described above; it can be practiced in various other aspects without departing from the inventive scope.

What is claimed is:

1. A maintenance guide generation method comprising:
detecting occurrences of a plurality of errors;
determining, on a basis of the detecting, whether the plurality of errors have occurred;
when the determining determines that the plurality of errors have occurred, reading, for each of the plurality of errors, a maintenance guide corresponding to the error and including a plurality of maintenance steps; and
generating a combined maintenance guide by combining the maintenance guides in a predetermined order while removing a duplicate maintenance step of the maintenance steps of the maintenance guides.

2. The maintenance guide generation method of claim 1, wherein
the maintenance guides include a first maintenance guide and a second maintenance guide, and
the generating generates the combined maintenance guide by combining the maintenance guides in the predetermined order so that the first maintenance guide is followed by the second maintenance guide, removing the duplicate maintenance step, and adding, between the first maintenance guide and the second maintenance guide, a step of indicating that the second maintenance guide exists following the first maintenance guide.

3. The maintenance guide generation method of claim 1, wherein the generating generates the combined maintenance guide by connecting the maintenance guides in the predetermined order to generate a connected maintenance guide, and when the maintenance steps of the maintenance guides include duplicate maintenance steps, leaving an earliest or latest one of the duplicate maintenance steps in the connected maintenance guide and removing other one or more of the duplicate maintenance steps from the connected maintenance guide.

4. The maintenance guide generation method of claim 1, wherein
the maintenance guides include a first maintenance guide and a second maintenance guide,
the plurality of maintenance steps of the first maintenance guide include a first maintenance step of changing an object from a first state to a second state and a second maintenance step of restoring the object from the second state to the first state,
the plurality of maintenance steps of the second maintenance guide include a first maintenance step of changing the object from the first state to the second state and a second maintenance step of restoring the object from the second state to the first state, and
the generating generates the combined maintenance guide by combining the maintenance guides in the predetermined order so that the first maintenance guide is prior to the second maintenance guide, and removing the second maintenance step of the first maintenance guide and the first maintenance step of the second maintenance guide.

5. The maintenance guide generation method of claim 4, wherein
the object is a cover, and
the first state is a closed state, and the second state is an open state.

6. The maintenance guide generation method of claim 1, wherein each of the maintenance guides is for removing a jammed sheet from an image forming apparatus.

7. The maintenance guide generation method of claim 1, further comprising presenting the combined maintenance guide.

8. An image forming apparatus comprising:
a detector that detects occurrences of a plurality of errors;
a determiner that determines, on a basis of detection by the detector, whether the plurality of errors have occurred;
a reader that, when the determiner determines that the plurality of errors have occurred, reads, for each of the plurality of errors, a maintenance guide corresponding to the error and including a plurality of maintenance steps, from a storage; and
a generator that generates a combined maintenance guide by combining the maintenance guides in a predetermined order while removing a duplicate maintenance step of the maintenance steps of the maintenance guides.

9. The image forming apparatus of claim 8, wherein
the maintenance guides include a first maintenance guide and a second maintenance guide, and
the generator generates the combined maintenance guide by combining the maintenance guides in the predetermined order so that the first maintenance guide is followed by the second maintenance guide, removing the duplicate maintenance step, and adding, between the first maintenance guide and the second maintenance guide, a step of indicating that the second maintenance guide exists following the first maintenance guide.

10. The image forming apparatus of claim 8, further comprising a presenter that displays the combined maintenance guide on a display provided in the image forming apparatus.

11. An image forming apparatus comprising:
a detector that detects occurrences of a plurality of errors;
a determiner that determines, on a basis of detection by the detector, whether the plurality of errors have occurred;
a reader that, when the determiner determines that the plurality of errors have occurred, reads, for each of the plurality of errors, a maintenance guide corresponding to the error and including a plurality of maintenance steps, from a storage, the maintenance guides including a first maintenance guide and a second maintenance guide; and
a generator that generates a combined maintenance guide by combining the maintenance guides so that the first maintenance guide is followed by the second maintenance guide, and adding, between the first maintenance guide and the second maintenance guide, a step of indicating that the second maintenance guide exists following the first maintenance guide.
